(19) United States
(12) Patent Application Publication
(10) Pub. No.: US 2007/0291814 A1
(43) Pub. Date: Dec. 20, 2007

(54) Insert and/or calibrator block formed of aluminum-bronze alloy, temperature calibration device using same, and methods of use

(75) Inventor: Michael W. Hirst, Lindon, UT (US)

Correspondence Address: Marcus Simon, Esq.;DORSEY & WHITNEY LLP, Suite 3400, 1420 Fifth Avenue, Seattle, WA, 98101, US

(73) Assignee: Fluke Corporation

(21) Appl. No.: 11/453,761

(22) Filed: Jun. 14, 2006

(51) Int. Cl. G01K 19/00; G01K 15/00

(52) U.S. Cl. 374/1

(57) ABSTRACT

Inserts and/or calibrator blocks formed of aluminum-bronze alloys resistant to environmental degradation, temperature calibration devices employing such inserts and calibrator blocks, and methods of using such devices and structures are disclosed. An insert and/or calibrator block for use with a temperature calibration device may be formed of an aluminum-bronze alloy having a composition selected to reduce environmental degradation thereof during use.

### TECHNICAL FIELD

This invention relates to temperature calibration devices. More particularly, this invention relates to inserts and calibrator blocks for use with the dry well calibrators that are formed of aluminum-bronze alloys resistant to environmental degradation.

### BACKGROUND OF THE INVENTION

Temperature calibration devices, also known as “dry well” calibrators, are used for calibrating high-precision temperature probes. Conventional dry well calibrators include removable inserts having formed therein elongated bores that receive temperature probes that are to be calibrated. The insert is configured to fit into a bore in a calibrator block that includes heating elements operable for controllably heating the calibrator block and consequently, the insert and temperature probe positioned therein, to a temperature set by a user. The insert is removable and is often changed depending upon the type and size of the temperature probe that is being calibrated.

In order to efficiently transfer heat to the insert, the calibrator blocks and inserts are typically formed of an alloy with a high thermal conductivity and the insert is dimensioned so that it is only slightly smaller than the dimension of the bore in the block. One alloy that is commonly used for the insert and calibrator block is the C63000 aluminum-bronze alloy, which has a composition of about 82 weight percent (wt %) copper, about 3 wt % iron, and about 5 wt % nickel. When the calibrator block and insert formed of alloy C63000 is heated above 600° C. to calibrate a temperature probe and subsequently allowed to cool, the cooling rate of the calibrator block and insert is such that the alloy C63000 undergoes phase transformations to form a microstructure with the face centered cubic alpha phase and at least one of the less corrosion resistant gamma 2 phase and beta phase, depending upon the cooling rate.

It is currently believed by the inventor that the interior surface of calibrator block and the outer surface of the insert can locally oxidize, form bumps or nodules, corrode, or otherwise suffer environmental degradation due to the presence of the beta and/or gamma 2 phases in the microstructure of the C63000 aluminum-bronze alloy. This environmental degradation of the alloy C63000 can result in the insert exhibiting a tighter interference fit with the calibrator block and the temperature probe exhibiting an tighter interference fit with the insert. Consequently, it can be difficult to remove the insert from the calibrator block and the temperature probe from the insert, particularly with the tight tolerances typically used for these components.

Therefore, there is a need for an insert and a calibrator block formed of an aluminum-bronze alloy that is compatible with the high temperatures experienced during calibration of a temperature probe so that the insert can be removed from the calibrator block and the temperature probe can be removed from the insert without experiencing binding between the mating components.

### SUMMARY OF THE INVENTION

This invention is directed to inserts and/or calibrator blocks formed of aluminum-bronze alloys resistant to environmental degradation, temperature calibration devices employing such inserts and calibrator blocks, and methods of using such devices and structures. In various aspects of the invention, an insert and/or calibrator block for use with a temperature calibration device may be formed of an aluminum-bronze alloy having a composition selected to reduce environmental degradation thereof. One such alloy may have an aluminum concentration less than about 8.5 wt %. The microstructure may be formed almost entirely of alpha phase without any or having insignificant amounts of beta and gamma 2 phases.

In another aspect of the invention, a temperature calibration device includes a calibrator block having a bore therein, a plurality of heating elements, and a temperature sensor. The heating elements and the temperature sensor are thermally coupled to the calibrator block. The temperature calibration device further includes an insert configured to be received by the bore of the calibrator block, the insert having at least one longitudinally extending bore suitably sized to receive a temperature probe. A control system is also coupled to the heating elements and the temperature sensor to control the heating of the calibrator block. At least one of the insert and the calibrator block may be formed of an aluminum-bronze alloy having a composition selected to reduce environmental degradation thereof.

In yet another aspect of the invention for use in calibrating a temperature probe using a temperature calibration device, a method includes inserting the temperature probe into an insert positioned within a bore formed in a calibrator block of the temperature calibration device. The insert and/or the calibrator block are formed of an aluminum-bronze alloy. The method further includes heating the insert and calibrator block to a temperature at least about 600° C. and calibrating the temperature probe at this temperature. The insert and calibrator block are cooled without forming the beta phase, gamma 2 phase, or both in the insert and/or calibrator block.

### BRIEF DESCRIPTION OF THE DRAWINGS

FIG. 1 is an exploded isometric view of some of the internal components of a temperature calibration device according to various embodiments of the invention.

FIG. 2 is a cross-sectional view of the internal components of the temperature calibration device shown in FIG. 1.

FIG. 3 is an exploded isometric view of a case surrounding the internal components of the temperature calibration device shown in FIG. 1.

FIG. 4 is an assembled front isometric view of the temperature calibration device of FIG. 3.

FIG. 5 is a block diagram showing one embodiment of a control system for the temperature calibration device of FIGS. 1-4.

### DETAILED DESCRIPTION OF THE EMBODIMENTS

Embodiments of the invention are directed to inserts and calibrator blocks formed of aluminum-bronze alloys resistant to environmental and thermal degradation, temperature calibration devices employing such inserts and calibrator blocks, and methods of using such devices and structures. Certain details are set forth below to provide a sufficient understanding of the invention. However, it will be clear to one skilled in the art that the invention may be practiced without these particular details. In other instances, well-known circuits, control signals, and timing protocols have not been shown in detail in order to avoid unnecessarily obscuring the description of the embodiments of the invention.

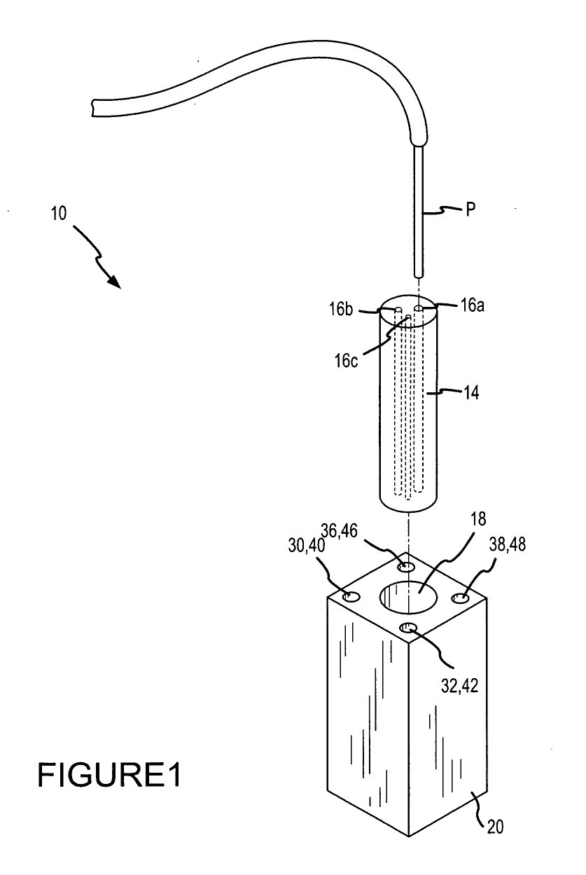

One aspect of the invention is directed to an insert 14 and calibrator block 20 formed of various of aluminum-bronze alloys for use in a dry well calibrator 10. The configuration of the insert 14, calibrator block 20, and dry well calibrator 10 are shown in FIGS. 1-3 and will be discussed in more detail below. At least one of the insert 14 and the calibrator block 20, and preferably both, are formed from an aluminum-bronze alloy selected to reduce the affect of the high temperatures that may be experienced during the temperature probe calibration process, which may be at or above 600° C. in some instances. It is preferable that such an aluminum-bronze alloy exhibit a microstructure formed almost entirely of the face centered cubic alpha phase and, thus, be substantially free of the beta and gamma 2 phases that are less resistant to environmental degradation. However, the aluminum-bronze alloy may contain other phases such as precipitates that do not generally affect the environmental degradation properties of the alloy. The composition of the aluminum-bronze alloy is selected to reduce the formation of the beta and gamma 2 phases upon cooling after heating the insert 14 and calibrator block 20 at or above 600° C. during calibration of a temperature probe, thereby, reducing local oxidation, forming of bumps or nodules, corrosion, or otherwise suffering environmental degradation.

In one embodiment, the insert 14 and/or calibrator block 20 are formed from an aluminum-bronze alloy having a composition with less than about 8.5 wt % aluminum and more preferably less than about 8 wt % aluminum. In another embodiment, the aluminum concentration may be preferably between about 6.0 to about 8.5 wt % aluminum.

In another embodiment, the insert 14 and/or calibrator block 20 are formed from aluminum-bronze alloy C61000 that has a composition of about 6.0 to about 8.5 wt % aluminum, less than about 0.50 wt % iron, less than about 0.02 wt % lead, less than about 0.20 wt % zinc, less than 0.10 wt % silicon, less than 0.50 wt % residual elements, and balance copper. In another embodiment, the insert 14 and/or calibrator block 20 are formed from aluminum-bronze alloy C61300 that has a composition of about 88.5 to about 91.5 wt % copper, about 6.0 to about 7.5 wt % aluminum, about 0.02 to about 0.50 wt % tin, about 2.0 to about 3.0 wt % iron, less than about 0.1 wt % manganese, about 0.15 wt % nickel and cobalt, less than about 0.01 wt % lead, and less than about 0.05 wt % zinc. In another embodiment, the insert 14 and/or calibrator block 20 are formed from aluminum-bronze alloy C61400 that has a composition of about 88.0 to about 92.5 wt % copper, about 6.0 to about 8.0 wt % aluminum, about 1.5 to about 3.0 wt % iron, less than about 1.0 wt % manganese, less than about 0.20 wt % zinc, less than about 0.01 wt % lead, less than about 0.015 wt % phosphorous, and less than about 0.5 wt % residual elements. In yet another embodiment, the insert 14 and/or calibrator block 20 are formed from aluminum-bronze alloy C61500 that has a composition of about 89.0 to 90.5 wt % copper, about 7.7 to about 8.3 wt % aluminum, about 1.8 to about 2.2 wt % nickel, and less than about 0.015 wt % lead. In the aluminum-bronze alloys containing a sufficient amount of iron (e.g., greater than 0.50 wt %), the microstructure may include iron-rich precipitates in addition to the alpha phase. However, it is not currently believed by the inventor that the iron-rich precipitates affect the environmental degradation properties of the alloy.

Another aspect of the invention is directed to the dry well calibrator 10 in which the insert 14 and/or calibrator block 20 are formed of any of the aforementioned aluminum-bronze alloys. FIG. 1 shows the internal components of a dry well calibrator 10 according to one embodiment of the invention. The dry well calibrator 10 includes the cylindrical insert 14 having a plurality of cylindrical bores 16a,b,c sized to receive temperature probes “P” having corresponding dimensions such as temperature probes P of having different diameters. The cylindrical bores 16a, b, c may extend longitudinally partially or completely through the insert 14. The clearance between the insert 14 and one of the probes P may be approximately 0.010 inches to approximately 0.015 inches.

The insert 14 fits into a cylindrical bore 18 formed in the calibrator block 20. The clearance between the insert 14 and the block 20 may be approximately 0.0050 inches to approximately 0.0090 inches. The calibrator block 20 has a configuration that is rectangular in both vertical and horizontal cross-section, although, of course, it may also have a circular cross-section or other configuration. The inside diameter of the bore 18 should be only slightly larger than the outside diameter of the insert 14 to ensure good heat conduction from the calibrator block 20 to the insert 14.

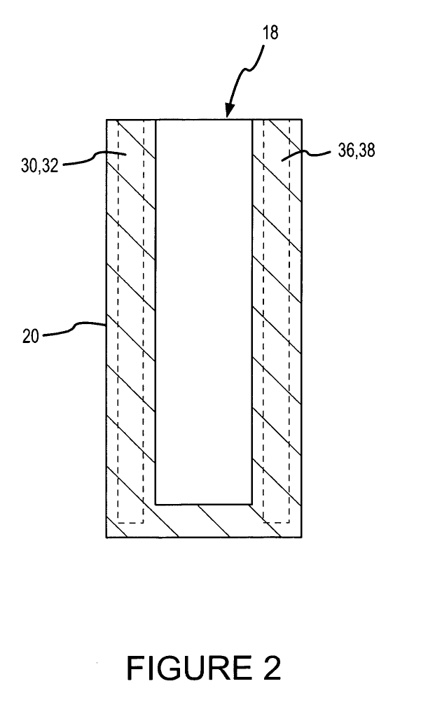

With further reference to FIG. 2, heating elements 30, 32, 36, 38 are placed in respective bores 40, 42, 46, 48 that extend vertically part way through the calibrator block 20 and may extend substantially parallel to the bore 18. The heating elements 30, 32, 36, 38 may be cartridge-type resistance heating elements, a cable resistance heating element that may wrap around the calibrator block 20, or another suitable heating element. In other embodiments, the heating elements 30, 32, 36, 38 may be positioned within or on the exterior of the calibrator block 20 to locally heat selected portions thereof, and some of the heating elements 30, 32, 36, 38 may be positioned horizontally or other orientations.

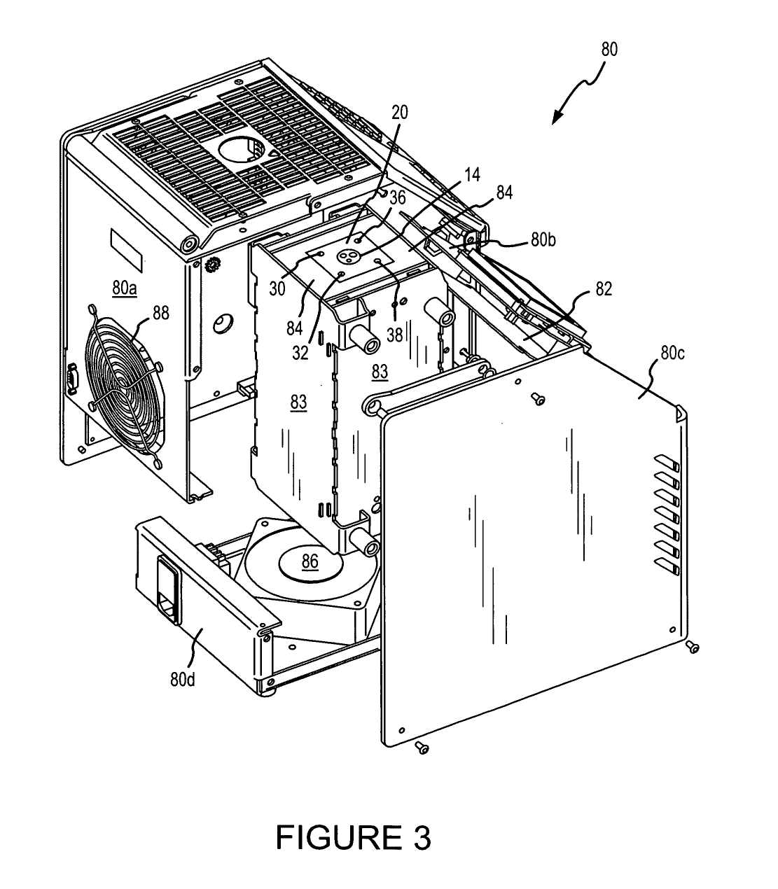

With reference also to FIG. 3, the above-described components of the dry well calibrator 10 are surrounded by an outer case 80 formed by case sections 80a,b,c,d. The case section 80b has circuitry 82 positioned behind it, which is connected to the heating elements 30, 32, 36, 38 for supplying power to the heating elements 30, 32, 36, 38. A fan 86 is positioned so that air blown thereby exits through a grill 88 in the case section 80a. The case 80 is separated from the calibrator block 20 by insulation (not shown) and an insulating space, and the fan 86 provides airflow through this insulating space to remove heat and maintain the circuitry 82 at a sufficiently low temperature. The calibrator block 20 is attached to a support structure 84 that is further attached to heat reflectors 83. The heat reflectors 83 partially surround the support structure 84 and the calibrator block 20 to help keep heat from transferring outside the case 80.

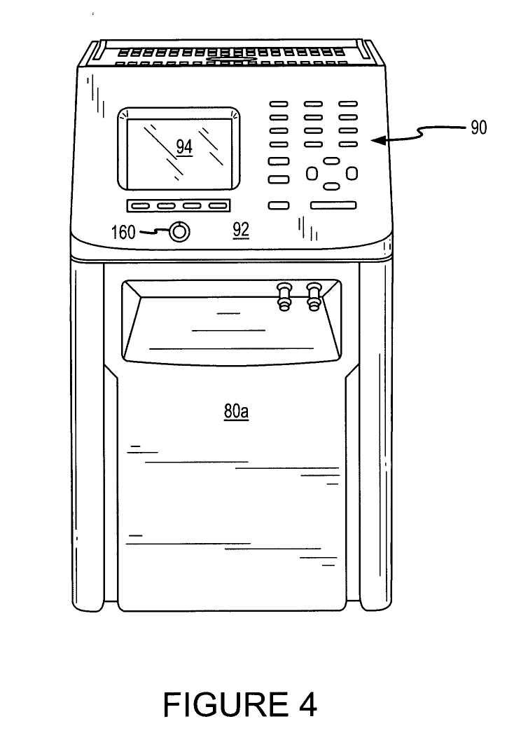

As best shown in FIG. 4, a keypad 90 mounted on a panel 92 of the case section 80a is connected to the circuitry 82 (FIG. 3) to control the operation of the dry well calibrator 10. A display 94, which is also connected to the circuitry 82 (FIG. 3), provides information about the operation of the dry well calibrator 10, such as the temperature of the calibrator block 20.

In operation, the keypad 90 (FIG. 4) is used to set the temperature of the calibrator block 20 as well as the rate at which the temperature of the calibrator block 20 is changed to reach the set temperature. Once the temperature of the calibrator block 20 has stabilized, the temperature probe P (FIG. 1) is inserted into a correspondingly sized bore 16 of the insert 14. The probe P is then calibrated by ensuring that a readout device (not shown) connected to the probe P indicates the temperature of the probe P is equal to the set temperature of the dry well calibrator 10.

By forming the insert 14 and/or calibrator block 20 from any of the aforementioned aluminum-bronze alloys, the insert 14 and calibrator block 20 will not significantly form deleterious phases, such as the beta and gamma 2 phases, after the probe P is calibrated to temperatures at or above 600° C. and subsequently cooled. Accordingly, the amount of environmental degradation such as localized oxidation, forming of nodules or bumps, corrosion, or other form of environmental degradation may be reduced on the insert 14 and calibrator block 20 thereby allowing the insert 14 to be more easily removed from the calibrator block 20 and the probe P from the insert 14 without excessive physical interference even when very tight clearances are used. In the embodiment where the insert 14 is formed from aluminum-bronze alloy C61300, the inventor has found that after calibrating the probe P at or above 600° C., the insert 14 can be removed from the calibrator block 20 and the probe P can be removed from the insert 14 without a significant amount of binding.

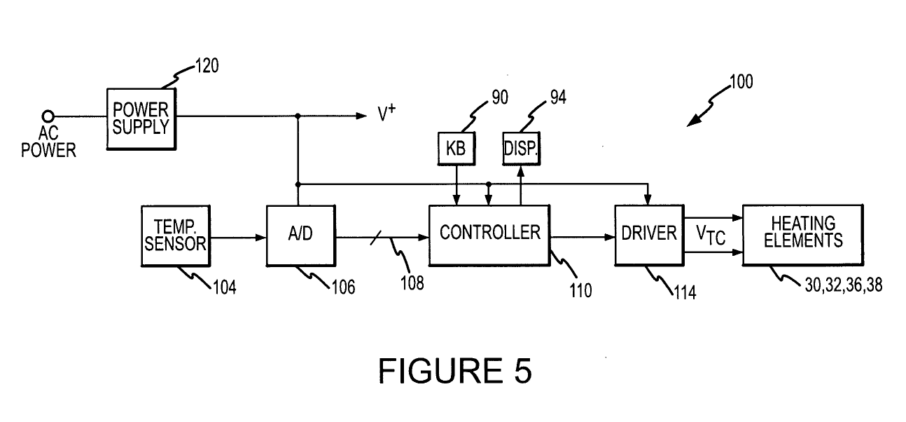

FIG. 5 shows one embodiment of a system 100 for controlling the operation of the temperature calibration device 10 shown in FIGS. 1-4. The control system 100 includes a temperature sensor 104 mounted on a surface to be monitored, such as the calibrator block 20 (FIGS. 1-3). The temperature sensor 104 provides an analog signal indicative of the temperature of the calibrator block 20. This analog signal is applied to an analog-to-digital (“A/D”) converter 106, which outputs a plurality of bits on a bus 108 indicative of the temperature of the calibrator block 20. These bits are applied to a controller 110, which may be implemented by conventional means such as a properly programmed microprocessor. The controller 110 receives user commands from the keypad 90 (FIG. 4) and applies signals to the display 94 for providing information to the user, as explained above. The controller 110 also outputs a temperature control signal to a driver 114, which, in turn, outputs a temperature control voltage V_{TC} to the heating elements 30, 32, 36, 38 (FIGS. 1 and 2). The above described components are powered by a supply voltage V⁺, which is generated by a power supply 120 from an AC supply voltage.

In normal operation, the user enters commands through the keypad 90, thereby causing the controller 110 to apply the temperature control voltage V_{TC} to the heating elements 30, 32, 36, 38 through the driver 114. During these keypad entries, the controller 110 can apply the appropriate signals to the display 94 to assist the user in operating the control system 100. The temperature of the calibrator block 20 will then increase or decrease depending on the polarity of the temperature control voltage V_{TC}. As the calibrator block 20 is heated, the temperature of the calibrator block 20 is monitored by the temperature sensor 104 to provide feedback to the controller 110. The controller 110 can then regulate the temperature control voltage V_{TC} to ensure that the temperature of the calibrator block 20 reaches the temperature set by the user using the keypad 90. The control system 100 may also be capable of controlling the rate that the temperature of the calibrator block 20 increases or decreases to the set temperature as well as the rate that the temperature of the calibrator block 20 returns to an ambient temperature.

Although the present invention has been described with reference to the disclosed embodiments, persons skilled in the art will recognize that changes may be made in form and detail without departing from the spirit and scope of the invention. Such modifications are well within the skill of those ordinarily skilled in the art. Accordingly, the invention is not limited except as by the appended claims.

What is claimed is:

1. An insert for use in a temperature calibration device, comprising:
an elongated body having at least one longitudinally extending bore suitably sized to receive a temperature probe, the elongated body comprised of an aluminum-bronze alloy having less than about 8.5 weight % aluminum.

2. The insert of claim 1 wherein the aluminum-bronze alloy has a microstructure that contains substantially only alpha phase.

3. The insert of claim 1 wherein the aluminum-bronze alloy has a microstructure that does not contain any beta phase or gamma 2 phase.

4. The insert of claim 1 wherein the aluminum-bronze alloy includes about 6.0 to about 8.5 weight % aluminum.

5. The insert of claim 1 wherein the aluminum-bronze alloy includes about 6.0 to about 8.5 weight (wt) % aluminum, less than about 0.50 wt % iron, less than about 0.02 wt % lead, less than about 0.20 wt % zinc, less than 0.10 wt % silicon, less than 0.50 wt % residual elements, and balance copper.

6. The insert of claim 1 wherein the aluminum-bronze alloy includes about 88.5 to about 91.5 wt % copper, about 6.0 to about 7.5 wt % aluminum, about 0.02 to about 0.50 wt % tin, about 2.0 to about 3.0 wt % iron, less than about 0.1 wt % manganese, about 0.15 wt % nickel and cobalt, less than about 0.01 wt % lead, and less than about 0.05 wt % zinc.

7. The insert of claim 1 wherein the aluminum-bronze alloy includes about 88.0 to about 92.5 weight (wt) % copper, about 6.0 to about 8.0 wt % aluminum, about 1.5 to about 3.0 wt % iron, less than about 1.0 wt % manganese, less than about 0.20 wt % zinc, less than about 0.01 wt % lead, less than about 0.015 wt % phosphorous, and less than about 0.5 wt % residual elements.

8. The insert of claim 1 wherein the aluminum-bronze alloy includes about 89.0 to 90.5 weight (wt) % copper, about 7.7 to about 8.3 wt % aluminum, about 1.8 to about 2.2 wt % nickel, and less than about 0.015 wt % lead.

9. The insert of claim 1 wherein the at least one longitudinally extending bore comprises a plurality of longitudinally oriented bores extending lengthwise at partially through the elongated body, each of the longitudinally oriented bores having a different diameter.

10. The insert of claim 1 wherein the elongated body is configured as a cylinder.

11. An insert for use with a temperature calibration device, comprising:
an elongated body having at least one longitudinally extending bore suitably sized to receive a temperature probe, the elongated body comprised of an aluminum-bronze alloy having a microstructure consisting essentially of alpha phase.

12. The insert of claim 11 wherein the aluminum-bronze alloy does not contain any beta phase or gamma 2 phase.

13. The insert of claim 11 wherein the aluminum-bronze alloy includes less than about 8.5 weight % aluminum.

14. The insert of claim 11 wherein the aluminum-bronze alloy includes about 6.0 to about 8.5 weight % aluminum.

15. The insert of claim 11 wherein the aluminum-bronze alloy includes about 6.0 to about 8.5 weight (wt) % aluminum, less than about 0.50 wt % iron, less than about 0.02 wt % lead, less than about 0.20 wt % zinc, less than 0.10 wt % silicon, less than 0.50 wt % residual elements, and balance copper.

16. The insert of claim 11 wherein the aluminum-bronze alloy includes about 88.5 to about 91.5 weight (wt) % copper, about 6.0 to about 7.5 wt % aluminum, about 0.02 to about 0.50 wt % tin, about 2.0 to about 3.0 wt % iron, less than about 0.1 wt % manganese, about 0.15 wt % nickel and cobalt, less than about 0.01 wt % lead, and less than about 0.05 wt % zinc.

17. The insert of claim 11 wherein the aluminum-bronze alloy includes about 88.0 to about 92.5 weight (wt) % copper, about 6.0 to about 8.0 wt % aluminum, about 1.5 to about 3.0 wt % iron, less than about 1.0 wt % manganese, less than about 0.20 wt % zinc, less than about 0.01 wt % lead, less than about 0.015 wt % phosphorous, and less than about 0.5 wt % residual elements.

18. The insert of claim 11 wherein the aluminum-bronze alloy includes about 89.0 to 90.5 weight (wt) % copper, about 7.7 to about 8.3 wt % aluminum, about 1.8 to about 2.2 wt % nickel, and less than about 0.015 wt % lead.

19. The insert of claim 11 wherein the at least one longitudinally extending bore comprises a plurality of longitudinally oriented bores extending lengthwise at least partially through the elongated body, each of the longitudinally oriented bores having a different diameter.

20. The insert of claim 11 wherein the elongated body is configured as a cylinder.

21. A calibrator block for use in a temperature calibration device, comprising:
a body having a bore suitably sized to receive an insert, the body comprised of an aluminum-bronze alloy having less than about 8.5 weight % aluminum.

22. The calibrator block of claim 21 wherein the aluminum-bronze alloy has a microstructure that contains substantially only alpha phase.

23. The calibrator block of claim 21 wherein the aluminum-bronze alloy has a microstructure that does not contain any beta phase or gamma 2 phase.

24. The calibrator block of claim 21 wherein the aluminum-bronze alloy includes about 6.0 to about 8.5 wt % aluminum.

25. The calibrator block of claim 21 wherein the aluminum-bronze alloy includes about 6.0 to about 8.5 wt % aluminum, less than about 0.50 wt % iron, less than about 0.02 wt % lead, less than about 0.20 wt % zinc, less than 0.10 wt % silicon, less than 0.50 wt % residual elements, and balance copper.

26. The calibrator block of claim 21 wherein the aluminum-bronze alloy includes about 88.5 to about 91.5 wt % copper, about 6.0 to about 7.5 wt % aluminum, about 0.02 to about 0.50 wt % tin, about 2.0 to about 3.0 wt % iron, less than about 0.1 wt % manganese, about 0.15 wt % nickel and cobalt, less than about 0.01 wt % lead, and less than about 0.05 wt % zinc.

27. The calibrator block of claim 21 wherein the aluminum-bronze alloy includes about 88.0 to about 92.5 wt % copper, about 6.0 to about 8.0 wt % aluminum, about 1.5 to about 3.0 wt % iron, less than about 1.0 wt % manganese, less than about 0.20 wt % zinc, less than about 0.01 wt % lead, less than about 0.015 wt % phosphorous, and less than about 0.5 wt % residual elements.

28. The calibrator block of claim 21 wherein the aluminum-bronze alloy includes about 89.0 to 90.5 wt % copper, about 7.7 to about 8.3 wt % aluminum, about 1.8 to about 2.2 wt % nickel, and less than about 0.015 wt % lead.

29. The calibrator block of claim 21 wherein the aluminum-bronze alloy includes less than about 8.0 wt % aluminum.

30. The calibrator block of claim 21:
wherein the body comprises a plurality of apertures extending through the body substantially parallel to the bore; and
further comprising a heating element positioned within each of the apertures.

31. A calibrator block for use in a temperature calibration device, comprising:
a body having a bore suitably sized to receive an insert, the body comprised of an aluminum-bronze alloy having a microstructure consisting essentially of alpha phase.

32. The calibrator block of claim 31 wherein the aluminum-bronze alloy does not contain any beta phase, gamma 2 phase, or both.

33. The calibrator block of claim 31 wherein the aluminum-bronze alloy includes less than about 8.5 weight % aluminum.

34. The calibrator block of claim 31 wherein the aluminum-bronze alloy includes about 6.0 to about 8.5 weight % aluminum.

35. The calibrator block of claim 31 wherein the aluminum-bronze alloy includes about 6.0 to about 8.5 weight (wt) % aluminum, less than about 0.50 wt % iron, less than about 0.02 wt % lead, less than about 0.20 wt % zinc, less than 0.10 wt % silicon, less than 0.50 wt % residual elements, and balance copper.

36. The calibrator block of claim 31 wherein the aluminum-bronze alloy includes about 88.5 to about 91.5 weight (wt) % copper, about 6.0 to about 7.5 wt % aluminum, about 0.02 to about 0.50 wt % tin, about 2.0 to about 3.0 wt % iron, less than about 0.1 wt % manganese, about 0.15 wt % nickel and cobalt, less than about 0.01 wt % lead, and less than about 0.05 wt % zinc.

37. The calibrator block of claim 31 wherein the aluminum-bronze alloy includes about 88.0 to about 92.5 weight (wt) % copper, about 6.0 to about 8.0 wt % aluminum, about 1.5 to about 3.0 wt % iron, less than about 1.0 wt % manganese, less than about 0.20 wt % zinc, less than about 0.01 wt % lead, less than about 0.015 wt % phosphorous, and less than about 0.5 wt % residual elements.

38. The calibrator block of claim 31 wherein the aluminum-bronze alloy includes about 89.0 to 90.5 weight (wt) % copper, about 7.7 to about 8.3 wt % aluminum, about 1.8 to about 2.2 wt % nickel, and less than about 0.015 wt % lead.

39. The calibrator block of claim 31:
wherein the body comprises a plurality of apertures extending through the body substantially parallel to the bore; and
further comprising a heating element positioned within each of the apertures.

40. A temperature calibration device, comprising:
a calibrator block having a bore therein;
a plurality of heating elements thermally coupled to the calibrator block;
a temperature sensor thermally coupled to the calibrator block;
an insert configured to be received by the bore of the calibrator block, the insert having at least one longitudinally extending bore suitably sized to receive a temperature probe, at least one of the insert and the calibrator block comprises an aluminum-bronze alloy having less than about 8.5 weight percent (wt %) of aluminum; and
a control system coupled to the heating elements and the temperature sensor.

41. The temperature calibration device of claim 40 wherein the aluminum-bronze alloy has a microstructure that contains substantially only alpha phase.

42. The temperature calibration device of claim 40 wherein the aluminum-bronze alloy has a microstructure that does not contain any beta phase or gamma 2 phase.

43. The temperature calibration device of claim 40 wherein the aluminum-bronze alloy includes less than about 8.5 wt % aluminum.

44. The temperature calibration device of claim 40 wherein the aluminum-bronze alloy includes about 6.0 to about 8.5 wt % aluminum.

45. The temperature calibration device of claim 40 wherein the aluminum-bronze alloy includes about 6.0 to about 8.5 wt % aluminum, less than about 0.50 wt % iron, less than about 0.02 wt % lead, less than about 0.20 wt % zinc, less than 0.10 wt % silicon, less than 0.50 wt % residual elements, and balance copper.

46. The temperature calibration device of claim 40 wherein the aluminum-bronze alloy includes about 88.5 to about 91.5 wt % copper, about 6.0 to about 7.5 wt % aluminum, about 0.02 to about 0.50 wt % tin, about 2.0 to about 3.0 wt % iron, less than about 0.1 wt % manganese, about 0.15 wt % nickel and cobalt, less than about 0.01 wt % lead, and less than about 0.05 wt % zinc.

47. The temperature calibration device of claim 40 wherein the aluminum-bronze alloy includes about 88.0 to about 92.5 wt % copper, about 6.0 to about 8.0 wt % aluminum, about 1.5 to about 3.0 wt % iron, less than about 1.0 wt % manganese, less than about 0.20 wt % zinc, less than about 0.01 wt % lead, less than about 0.015 wt % phosphorous, and less than about 0.5 wt % residual elements.

48. The temperature calibration device of claim 40 wherein the aluminum-bronze alloy includes about 89.0 to 90.5 wt % copper, about 7.7 to about 8.3 wt % aluminum, about 1.8 to about 2.2 wt % nickel, and less than about 0.015 wt % lead.

49. The temperature calibration device of claim 40 wherein the at least one longitudinally extending bore comprises a plurality of longitudinally oriented bores extending lengthwise at least partially through the elongated body, each of the longitudinally oriented bores having a different diameter.

50. The temperature calibration device of claim 40 wherein the elongated body of the insert is configured as a cylinder.

51. The temperature calibration device of claim 40 wherein the calibrator block comprises a plurality of apertures extending substantially parallel to the bore, each of the heating elements being received by a corresponding one of the apertures.

52. The temperature calibration device of claim 40 wherein each of the heating elements comprises a resistance heating element.

53. A temperature calibration device, comprising:
a calibrator block having a bore therein;
a plurality of heating elements thermally coupled to the calibrator block;
a temperature sensor thermally coupled to the calibrator block;
an insert configured to be received by the bore of the calibrator block, the insert having at least one longitudinally extending bore suitably sized to receive a temperature probe, at least one of the insert and the calibrator block comprises an aluminum-bronze alloy consisting essentially of alpha phase; and
a control system coupled to the heating elements and the temperature sensor.

54. The temperature calibration device of claim 53 wherein the aluminum-bronze alloy does not contain any beta phase or gamma 2 phase.

55. The temperature calibration device of claim 53 wherein the aluminum-bronze alloy includes less than about 8.5 weight % aluminum.

56. The temperature calibration device of claim 53 wherein the aluminum-bronze alloy includes about 6.0 to about 8.5 weight % aluminum.

57. The temperature calibration device of claim 53 wherein the aluminum-bronze alloy includes about 6.0 to about 8.5 weight (wt) % aluminum, less than about 0.50 wt % iron, less than about 0.02 wt % lead, less than about 0.20 wt % zinc, less than 0.10 wt % silicon, less than 0.50 wt % residual elements, and balance copper.

58. The temperature calibration device of claim 53 wherein the aluminum-bronze alloy includes about 88.5 to about 91.5 weight (wt) % copper, about 6.0 to about 7.5 wt % aluminum, about 0.02 to about 0.50 wt % tin, about 2.0 to about 3.0 wt % iron, less than about 0.1 wt % manganese, about 0.15 wt % nickel and cobalt, less than about 0.01 wt % lead, and less than about 0.05 wt % zinc.

59. The temperature calibration device of claim 53 wherein the aluminum-bronze alloy includes about 88.0 to about 92.5 weight (wt) % copper, about 6.0 to about 8.0 wt % aluminum, about 1.5 to about 3.0 wt % iron, less than about 1.0 wt % manganese, less than about 0.20 wt % zinc, less than about 0.01 wt % lead, less than about 0.015 wt % phosphorous, and less than about 0.5 wt % residual elements.

60. The temperature calibration device of claim 53 wherein the aluminum-bronze alloy includes about 89.0 to 90.5 weight (wt) % copper, about 7.7 to about 8.3 wt % aluminum, about 1.8 to about 2.2 wt % nickel, and less than about 0.015 wt % lead.

61. The temperature calibration device of claim 53 wherein the at least one longitudinally extending bore comprises a plurality of longitudinally oriented bores extending lengthwise at least partially through the elongated body, each of the longitudinally oriented bores having a different diameter.

62. The temperature calibration device of claim 53 wherein the elongated body of the insert is a cylinder.

63. The temperature calibration device of claim 53 wherein the calibrator block comprises a plurality of apertures extending substantially parallel to the bore, each of the heating elements being received by a corresponding one of the apertures.

64. The temperature calibration device of claim 53 wherein each of the heating elements comprises a resistance heating element.

65. In a temperature calibration device, a method of calibrating a temperature probe, the method comprising:
inserting the temperature probe into an insert positioned within a bore formed in a calibrator block of the temperature calibration device, at least one of the insert and the calibrator block comprising an aluminum-bronze alloy;
heating the insert and calibrator block to a temperature at least about 600° C.;
calibrating the temperature probe at the temperature; and
cooling the insert and calibrator block without forming at least one of the beta phase and gamma 2 phase in at least one of the insert and calibrator block.

66. The method of claim 65, further comprising:
after the act of cooling the insert and calibrator block, removing the insert from the bore of the calibrator block without experiencing a substantial amount of physical interference between the insert and the calibrator block.

67. The method of claim 65 wherein both the insert and the calibrator block comprise the aluminum-bronze alloy.

68. The method of claim 65 wherein the act of heating the insert and calibrator block to a temperature at least about 600° C. comprises heating the insert and calibrator block to a temperature above 600° C.
